(19) United States
(12) Patent Application Publication
(10) Pub. No.: US 2015/0147584 A1
(43) Pub. Date: May 28, 2015

(54) FIBROUS COPPER MICROPARTICLES AND METHOD FOR MANUFACTURING SAME

(71) Applicants: Munenori Yamada, Kyoto (JP); Kou Takeuchi, Kyoto (JP); Mutsumi Matsushita, Kyoto (JP); Akira Shigeta, Kyoto (JP); Masahiro Hosoda, Kyoto (JP); Yoshiaki Echigo, Kyoto (JP)

(72) Inventors: Munenori Yamada, Kyoto (JP); Kou Takeuchi, Kyoto (JP); Mutsumi Matsushita, Kyoto (JP); Akira Shigeta, Kyoto (JP); Masahiro Hosoda, Kyoto (JP); Yoshiaki Echigo, Kyoto (JP)

(73) Assignee: UNITIKA LTD., Hyogo (JP)

(21) Appl. No.: 14/405,166

(22) PCT Filed: Jun. 11, 2013
(86) PCT No.: PCT/JP2013/066012

§ 371 Date: Dec. 3, 2014

(30) Foreign Application Priority Data
Jun. 11, 2012 (JP) 2012-131651

(51) Int. Cl. B22F 1/00; B22F 9/24; C22C 9/00; H01B 1/02

(52) U.S. Cl. CPC B22F 1/004; H01B 1/026; B22F 9/24; C22C 9/00
USPC 428/544; 428/328; 75/373; 420/469

(57) ABSTRACT

Fibrous copper microparticles having a minor axis of 1 μm or less and an aspect ratio of 10 or more, wherein the content of the copper particles having a minor axis of 0.3 μm or more and an aspect ratio of 1.5 or less is 0.1 or less copper particle per one fibrous copper microparticle.

### TECHNICAL FIELD

The present invention relates to fibrous copper microparticles copper reduced in the content of copper particles and a method for manufacturing the same.

### BACKGROUND ART

Recently, electrically conductive materials having transparency (transparent electrically conductive materials) typified by transparent electrically conductive films have been drastically expanded in applications to, for example, touch panels and flat panel displays. However, the inorganic oxides used as electrically conductive materials in the transparent electrically conductive materials are expensive materials and poor in processability.

On the other hand, copper microparticles as electrically conductive materials are materials excellent in electrical conductivity and inexpensive, and hence are widely used in electrically conductive materials for electrically conductive coating agents or the like. Such electrically conductive coating agents are widely used as, for example, materials for forming circuits on printed wiring boards produced by using various printing methods, and various electrical contact members.

Accordingly, it has been required to form a layer excellent in electrical conductivity, and additionally high in optical transmission property in the visible light region and excellent in transparency by using an electrically conductive coating agent employing copper microparticles as an electrically conductive material.

On the basis of such requirements, various investigations have been made on metal microparticles including copper microparticles capable of forming layers having optical transmission property in the visible light region and the methods for manufacturing such metal microparticles. For example, Patent Literature 1 discloses fibrous copper microparticles and a method for manufacturing the same, and Patent Literature 2 discloses rod-shaped metal particles and a method for manufacturing the same.

### CITATION LIST

### Patent Literature

Patent Literature 1: International Publication No. WO 2011/071885

Patent Literature 2: JP2009-215573A

### SUMMARY OF INVENTION

### Technical Problem

The fibrous copper microparticles described in Patent Literature 1 and the rod-shaped metal microparticles described in Patent Literature 2 are excellent in electrical conductivity, and hence are promising as electrically conductive materials. However, the electrically conductive layers containing the microparticles described in Patent Literature 1 and Patent Literature 2 are disadvantageously poor in transparency.

An object of the present invent ion is to provide fibrous copper microparticles which solve the foregoing problems, and form a layer excellent not only in electrical conductivity but also in transparency when contained in an electrically conductive layer. Moreover, another object of the present invention is to provide an electrically conductive coating agent containing the fibrous copper microparticles, an electrically conductive layer containing the fibrous copper microparticles and an electrically conductive film including the electrically conductive layer on a substrate.

### Solution to Problem

The present inventors made a diligent study in order to solve the foregoing problems, and consequently have reached the present invention by discovering that the fibrous copper microparticles in which the minor axis is 1 μm or less and the aspect ratio is 10 or more and the content of the copper particles having a minor axis of 0.3 μm or more and an aspect ratio of 1.5 or less is 0.1 or less copper particle per one fibrous copper microparticle can be an electrically conductive material excellent both in electrical conductivity and in transparency when contained in a transparent electrically conductive material.

Moreover, the present inventors have discovered that the fibrous copper microparticles can be produced by precipitating from an aqueous solution while the precipitation of copper particles is being suppressed on the basis of the use of a specific reducing compound.

Specifically, the gist of the present invention resides in the following.

(1) Fibrous copper microparticles having a minor axis of 1 μm or less and an aspect ratio of 10 or more, wherein the content of the copper particles having a minor axis of 0.3 μm or more and an aspect ratio of 1.5 or less is 0.1 or less copper particle per one fibrous copper microparticle.

(2) The fibrous copper microparticles of (1), wherein the length of the fibrous copper microparticles is 1 μm or more.

(3) A method for manufacturing the fibrous copper microparticles one of (1) and (2), including precipitating the fibrous copper microparticles from an aqueous solution containing copper ion, an alkaline compound, a nitrogen-containing compound to form a complex with copper ion, and a reducing compound, wherein the residual rate A of the dissolved oxygen concentration in the alkaline aqueous solution represented by the following formula [1] is 0.5 or more:

Residual rate A of dissolved oxygen concentration=(Dissolved oxygen concentration (C₁₀) after 10 minutes from addition of reducing compound)/(dissolved oxygen concentration (C₀) before addition of reducing compound) [1]

(4) The method for manufacturing fibrous copper microparticles of (3), wherein the reducing compound is one or more compounds selected from ascorbic acid, erythorbic acid and glucose.

(5) The method for manufacturing fibrous copper microparticles of (3), wherein the residual rate B of the dissolved oxygen concentration in the alkaline aqueous solution represented by the following formula [2] is 0.9 or less:

Residual rate B of dissolved oxygen concentration=(Dissolved oxygen concentration (C₆₀) after 60 minutes from addition of reducing compound)/(dissolved oxygen concentration (C₁₀) after 10 minutes from addition of reducing compound) [2]

(6) The method for manufacturing fibrous copper microparticles of (5), wherein the reducing compound is ascorbic acid and/or erythorbic acid.

(7) An electrically conductive coating agent including the fibrous copper microparticles one of (1) and (2).

(8) An electrically conductive layer including the fibrous copper microparticles one of (1) and (2).

(9) An electrically conductive film including a substrate, and the electrically conductive layer of (8), formed on the substrate.

### Advantageous Effects of Invention

The fibrous copper microparticles of the present invention have specific shapes and constitutions such that the fibrous copper microparticles are fibrous copper microparticles having a minor axis of 1 μm or less and an aspect ratio of 10 or more, wherein the content of the copper particles having a minor axis of 0.3 μm or more and an aspect ratio of 1.5 or less is 0.1 or less copper particle per one fibrous copper microparticle. Accordingly, by using the fibrous copper microparticles of the present invention, an electrically conductive coating agent, an electrically conductive layer and an electrically conductive film having at the same time excellent electrical conductivity and excellent transparency can be obtained.

Additionally, according to the production method of the present invention, by using a specific reducing compound, the fibrous copper microparticles of the present invention can be easily produced.

### BRIEF DESCRIPTION OF DRAWINGS

FIG. 1 is a view showing a state in which the minor axes and the lengths of the fibrous copper microparticles and the minor axes and the major axes of the copper particles cannot be properly evaluated because the fibrous copper microparticles crowd.

FIG. 2 is a view showing a state in which the fibrous copper microparticles do not crowd, and the minor axes and the lengths of the fibrous copper microparticles and the minor axes and the major axes of the copper particles can be measured.

FIG. 3 is a graph showing the reactivity of each of the various reducing compounds with the dissolved oxygen in an alkaline aqueous solution.

FIG. 4 is a digital microscopic observation view of the fibrous copper microparticles obtained in Example 1.

FIG. 5 is a digital microscopic observation view of the fibrous copper microparticles obtained in Example 1.

FIG. 6 is a digital microscopic observation view of the fibrous copper microparticles obtained in Example 2.

FIG. 7 is a digital microscopic observation view of the fibrous copper microparticles obtained in Example 3.

FIG. 8 is a digital microscopic observation view of the fibrous copper microparticles obtained in Example 4.

FIG. 9 is a digital microscopic observation view of the fibrous copper microparticles obtained in Comparative Example 1.

FIG. 10 is a digital microscopic observation view of the fibrous copper microparticles obtained in Comparative Example 2.

FIG. 11 is a digital microscopic observation view of the fibrous copper microparticles obtained in Comparative Example 3.

FIG. 12 is a digital microscopic observation view of the fibrous copper microparticles obtained in Comparative Example 4.

### DESCRIPTION OF EMBODIMENTS

Hereinafter, the present invention is described in detail.

The fibrous copper microparticles of the present invention are fibrous copper microparticles having a minor axis of 1 μm or less and an aspect ratio of 10 or more, wherein the content of the copper particles having a minor axis of 0.3 μm or more and an aspect ratio of 1.5 or less is 0.1 or less copper particle per one fibrous copper microparticle.

In general, fibrous copper microparticles involve the formation of copper particles in such a way that the copper particles attach the end portions or the side portions of the fibrous copper microparticles in a manner integrated with the fibrous copper microparticles, or alternatively, in such a way that the copper particles are brought into contact with the fibrous copper microparticles in a manner not integrated with the fibrous copper microparticles. When the fibrous copper microparticles containing the copper particles are used as an electrically conductive material for an electrically conductive layer, the included copper particles cause a remarkable degradation of the transparency of the electrically conductive layer. The present invention has discovered that the control of the content of the copper particles so as to fall within a specific range, namely, the use of the fibrous copper microparticles for which the formation of the copper particles is suppressed allows a transparent electrically conductive material to maintain excellent transparency along with the electrical conductivity when such fibrous copper microparticles are included as an electrically conductive material in the transparent electrically conductive material.

In the fibrous copper microparticles of the present invention, the minor axis is required to be 1 μm or less, and is preferably 0.5 μm or less, more preferably 0.2 μm or less and furthermore preferably 0.1 μm or less. When the minor axis of the fibrous copper microparticles exceeds 1 μm, the electrically conductive layer containing the fibrous copper microparticles is sometimes poor in transparency.

The length of the fibrous copper microparticles is preferably 1 μm or more, more preferably 5 μm or more and furthermore preferably 10 μm or more. When the length of the fibrous copper microparticles is less than 1 μm, in the electrically conductive layer containing the fibrous copper microparticles of the present invention, it is sometimes difficult to make the satisfactory electrical conductivity and the satisfactory transparency compatible with each other. On the other hand, from the viewpoint of the handling of the coating agent for forming an electrically conductive layer, it is sometimes preferable for the length of the fibrous copper microparticles not to exceed 500 μm.

The aspect ratio (length of fibrous body/minor axis of fibrous body) of the fibrous copper microparticles is required to be 10 or more, and is preferably 100 or more and more preferably 300 or sore. When the aspect ratio of the fibrous copper microparticles is less than 10, it is sometimes difficult to make the transparency and the electrical conductivity compatible with each other in the transparent electrically conductive material containing the fibrous copper microparticles.

The copper particles in the present invention are copper particles having a shape of 0.3 μm or more in the minor axis and 1.5 or less in the aspect ratio (major axis of copper particles/minor axis of copper particles).

In the fibrous copper microparticles of the present invention, the content of the copper particles is required to be 0.1 or less copper particle per one fibrous copper microparticle, is preferably 0.08 or less copper particle and more preferably 0.05 or less copper particle per one fibrous copper microparticle, and most preferably the copper particles are absent. When the content of the copper particles exceeds 0.1 copper particle per one fibrous copper microparticle, the electrically conductive layer containing the fibrous copper microparticles is poor in transparency.

In Patent Literature 1, when particulate copper microparticles grow into fibrous copper microparticles, a large amount of copper particles are formed in a state in which the copper particles attach to the ends and sides of the fibrous copper microparticles or in a state in which the copper particles are brought into contact with the fibrous copper microparticles, but are not integrated with the fibrous copper microparticles. When the fibrous copper microparticles containing such copper particles in a large amount are contained in an electrically conductive layer, the fibrous copper microparticles offer a factor degrading the transparency of the layer.

In the present invention, the fibrous copper microparticles are produced by the below-described method, and hence the content of the copper particles can be reduced.

In the present invention, the methods for determining the minor axis and the length of the fibrous copper microparticles and the minor axis and the major axis of the copper particles, and the method for deriving the number of the copper particles per one fibrous copper particle are as follows.

First, the aggregates of the fibrous copper microparticles are observed by using a transmission electron microscope (TEM) or a scanning electron microscope (SEM). From the aggregates, 100 fibrous copper microparticles are selected. The minor axis and the length of each of the selected fibrous copper microparticles are measured, and the average value of the resulting minor axis values and the average value of the resulting length values are taken respectively as the minor axis and the length of the fibrous copper microparticles; and by dividing the thus derived length by the thus derived minor axis, the aspect ratio of the fibrous copper microparticles is derived. The minor axis and the major axis of each of the copper particles attaching to or contacting with the selected fibrous copper microparticles are measured, and the average value of the resulting minor axis values and the average value of the resulting major axis values are taken respectively as the minor axis and the major axis of the copper particles; and by dividing the thus derived major axis by the thus derived minor axis, the aspect ratio of the copper particles is derived. Moreover, by counting the number of the copper particles present and by dividing the number of the copper particles by the number (100) of the fibrous copper microparticles, the number of the copper particles per one fibrous copper microparticle is derived.

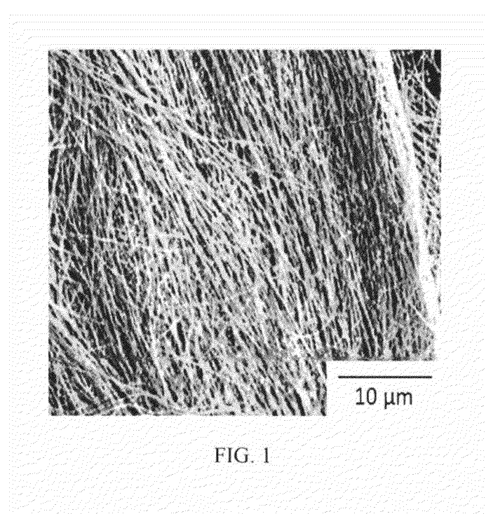

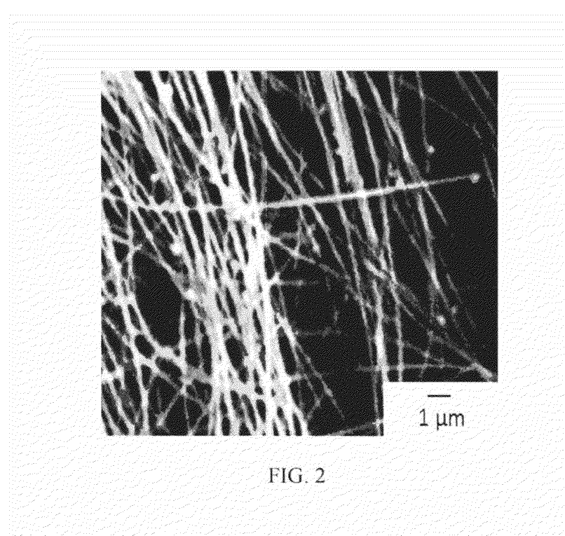

In the observation of the fibrous copper microparticles, in the case where the fibrous copper microparticles overlap each other and crowd each other, and shapes of the fibrous copper microparticles and the shapes of the copper particles cannot be accurately measured (see, FIG. 1), by using, for example, an ultrasonic disperser, the crowding fibrous copper microparticles are disentangled to such an extent that the neighboring fibrous copper microparticles are not in close contact with each other (see, FIG. 2).

Next, the method for manufacturing the fibrous copper microparticles of the present invention is described.

The method for manufacturing the fibrous copper microparticles of the present invention includes the step of precipitating the fibrous copper microparticles from an aqueous solution containing copper ion, an alkaline compound, a nitrogen-containing compound to form a complex with copper ion, and a reducing compound, wherein the reducing compound used is a compound allowing the residual rate A of the dissolved oxygen concentration in the alkaline aqueous solution, represented by the following formula [1] to be 0.5 or more:

Residual rate A of dissolved oxygen concentration=(Dissolved oxygen concentration (C₁₀) after 10 minutes from addition of reducing compound)/(dissolved oxygen concentration (C₀) before addition of reducing compound) [1]

As the copper ion to be used for the production of the fibrous copper microparticles, the copper ion produced by dissolving a water-soluble copper salt in water can be used. Examples of the water-soluble copper salt include copper sulfate, copper nitrate, copper chloride and copper acetate. Among these, copper sulfate or copper nitrate can be preferably used from the viewpoint of the easiness in forming the fibrous copper microparticles of the present invention.

The copper ion concentration in the aqueous solution is preferably 0.0005 to 0.5% by mass and more preferably 0.01 to 0.2% by mass. When the copper ion concentration is less than 0.0005% by mass, the production efficiency of the fibrous copper microparticles is low, and on the other hand, when the copper ion concentration exceeds 0.5% by mass, the copper particles sometimes tend to be produced.

Examples of the alkaline compound used in the production of the fibrous copper microparticles include, without being particularly limited to: sodium hydroxide and potassium hydroxide.

The concentration of the alkaline compound in the aqueous solution is preferably 13 to 50% by mass, more preferably 0.10 to 50% by mass and furthermore preferably 35 to 45% by mass. When the concentration of the alkaline compound is less than 15% by mass, it sometimes becomes difficult to form the fibrous copper microparticles, and on the other hand, when the concentration of the alkaline compound exceeds 50% by mass, the handling of the aqueous solution sometimes becomes difficult.

The content of the hydroxide ion of the alkaline compound in the aqueous solution is preferably 3000 to 6000 moles and more preferably 3000 to 5000 moles in relation to 1 mole of copper ion. When the content of the hydroxide ion of the alkaline compound is less than 3000 moles, the formation of the copper particles cannot be suppressed, and the content of the copper particles sometimes exceeds 0.1 copper particle per one fibrous copper microparticle, and the fibrous copper microparticles having the shape specified in the present invention sometimes cannot be obtained. On the other hand, the content of the hydroxide ion of the alkaline compound exceeds 6000 moles, the formation efficiency of the fibrous copper microparticles is sometimes degraded.

Examples of the nitrogen-containing compound to form a complex with copper ion, used for the production of the fibrous copper microparticles, include ammonia, ethylenediamine and triethylenetetramine; among these, ethylenediamine is preferable because of the easiness in forming the fibrous copper microparticles.

The content of the nitrogen-containing compound to form the complex in the aqueous solution is preferably 1 mole or more in relation to 1 mole of copper ion from the viewpoint of the formation efficiency of the fibrous copper microparticles.

The reducing compound used in the production of the fibrous copper microparticles is required to give 0.5 or more to the residual rate A of the dissolved oxygen concentration in the alkaline aqueous solution represented by the following formula [1]:

Residual rate A of dissolved oxygen concentration=(Dissolved oxygen concentration (C₁₀) after 10 minutes from addition of reducing compound)/(dissolved oxygen concentration (C₀) before addition of reducing compound) [1]

The residual rate A of the dissolved oxygen concentration in the alkaline aqueous solution (hereinafter, sometimes abbreviated as the value A) is the ratio of the dissolved oxygen concentration (C₁₀) after 10 minutes from the addition of the reducing compound to the dissolved oxygen concentration (C₀) before the addition of the reducing compound, as shown in formula [1]. Accordingly, the lower the value A of a reducing compound, the more easily the reducing compound reacts with the dissolved oxygen in the alkaline aqueous solution, during 10 minutes after the addition of the reducing compound, and the higher the value A of a reducing compound, the more hardly the reducing compound reacts with the dissolved oxygen in the alkaline aqueous solution.

In the present invention, it is necessary to use a reducing compound having the value A of 0.5 or more. The value A of the reducing compound less than 0.5 results in a state in which not only the fibrous copper microparticles but also the copper particles tend to be produced, and sometimes results in a state in which the diameter of the particles to serve as the starting sites of the precipitation grows to be larger than the diameter of the fibrous copper microparticles.

When a reducing agent having the value A, specified in the present invention, of 0.5 or more is used, copper precipitates relatively slowly, the precipitation of the copper particles is suppressed, the fibrous copper microparticles precipitate preferentially, and consequently the fibrous copper microparticles relatively small in the content of the copper particles are obtained.

The reducing compound used in the production of the fibrous copper microparticles preferably gives 0.9 or less to the residual rate B of the dissolved oxygen concentration, represented by the following formula [2], in the alkaline aqueous solution:

Residual rate B of dissolved oxygen concentration=(Dissolved oxygen concentration (C₆₀) after 60 minutes from addition of reducing compound)/(dissolved oxygen concentration (C₁₀) after 10 minutes from addition of reducing compound) [2]

The residual rate B of the dissolved oxygen concentration in the alkaline aqueous solution (hereinafter, sometimes abbreviated as the value B) is the ratio of the dissolved oxygen concentration (C₆₀) after 60 minutes from the addition of the reducing compound to the dissolved oxygen concentration (C₁₀) after 10 minutes from the addition of the reducing compound, as shown in formula [2]. Accordingly, the lower the value B of a reducing compound, the more easily the reducing compound reacts with the dissolved oxygen in the alkaline aqueous solution, also during the time of period from 10 minutes to 60 minutes after the addition of the reducing compound, and the higher the value B of a reducing compound, the more hardly the reducing compound reacts with the dissolved oxygen in the alkaline aqueous solution.

In the present invention, it is preferable to use a reducing compound having a value B of 0.9 or less. When the value B of the reducing compound exceeds 0.9, the precipitation of the fibrous copper microparticles themselves becomes slow, and the competition between the production of the fibrous copper microparticles and the production of the copper particles sometimes causes the obtained fibrous copper microparticles to have a larger content of the copper particles.

When a reducing agent having the value B, specified in the present invention, of 0.9 or less is used, the fibrous copper microparticles precipitate preferentially and stably with the passage of time, and consequently the fibrous copper microparticles small in the content of the copper particles are efficiently obtained.

In the present invention, examples of the reducing compound having the value A of 0.5 or more include ascorbic acid (value A: 0.90), erythorbic acid (value A: 0.96) and glucose (value A: 0.97). Among these, examples of the reducing compound having the value B of 0.90 or less include ascorbic acid (value B: 0.67) and erythorbic acid (value B: 0.73). In the present invention, it is preferable to use one or more selected from these reducing compounds, and it is most preferable to use ascorbic acid.

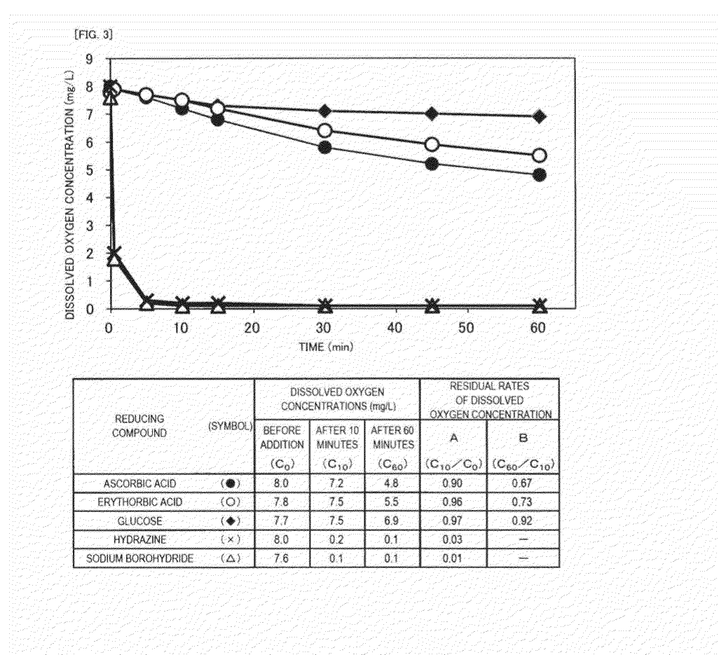

FIG. 3 is a graph showing the relation between the dissolved oxygen concentration (mg/L) in the alkaline aqueous solution and the time measured for each of the various reducing compounds under the below-described conditions. As shown in FIG. 3, when ascorbic acid, erythorbic acid and glucose are used as the reducing compounds, even after 10 minutes and 60 minutes from the addition of each of these reducing compounds, the alkaline aqueous solution maintains a high dissolved oxygen concentration.

On the other hand, when hydrazine or sodium borohydride are used as the reducing compounds, the dissolved oxygen concentration in the alkaline aqueous solution is rapidly and remarkably decreased. The value A of hydrazine is 0.03, and the value A of sodium borohydride is 0.01.

In the related art, in general, hydrazine is used as the reducing compound; when a reducing compound easily reacting with the dissolved oxygen such as hydrazine is used, disadvantageously only the fibrous copper microparticles having an increased content of the copper particles are obtained, and in some cases, the fibrous copper microparticles themselves were not able to be precipitated.

In the present invention, the content of the reducing compound in the aqueous solution is preferably 0.5 to 5.0 moles and more preferably 0.75 to 3.0 moles in relation to 1 mole of copper ion. When the content of the reducing compound is less than 0.5 mole, the formation efficiency of the fibrous copper microparticles is sometimes degraded. On the other hand, when the content of the reducing compound exceeds 5.0 moles, the effect of the reducing compound is saturated to be unfavorable from, the viewpoint of, for example, the cost.

The aqueous solution containing copper ion, the alkaline compound, the nitrogen-containing compound to form a complex with copper ion and the reducing compound is heated, and then, by continuing the heating of the aqueous solution or by decreasing the temperature of the aqueous solution, the fibrous copper microparticles can be precipitated. In particular, the latter method, namely, the method decreasing the solution temperature after heating is preferable. The temperature for heating the aqueous solution is not particularly limited, but is preferably 50 to 100° C. from the viewpoint of the balance between the precipitation efficiency and the cost.

Alternatively, the fibrous copper microparticles can also be continuously precipitated by using, for example, a flow-type reactor.

In the present invention, it is preferable to add the reducing compound in fractions to the aqueous solution containing copper ion, the alkaline compound and the nitrogen-containing compound to form a complex with copper ion. By adding the reducing compound in fractions, the production of the particles can be suppressed.

The precipitated fibrous copper microparticles can be collected by performing solid-liquid separation based on a method such as filtration, centrifugal separation or pressure floatation. Moreover, if necessary, the collected fibrous copper microparticles may also be washed or dried.

The operation of collecting the fibrous copper microparticles by solid-liquid separation tends to oxidise the surface of the fibrous copper microparticles, and is preferably performed in an atmosphere of an inert gas such as nitrogen gas. The collected fibrous copper microparticles are preferably stored in an atmosphere of an inert gas such as nitrogen gas, or preferably stored as dispersed, for example, in a solution in which an organic substance or a reducing compound having a function to prevent the oxidation of copper is dissolved in a trace amount.

The electrically conductive coating agent of the present invention contains the fibrous copper microparticles of the present invention, and can be prepared by mixing and dispersing, in a binder component and a solvent, the fibrous copper microparticles.

The binder component constituting the electrically conductive coating agent is not particularly limited, and examples of the usable binder components include: acrylic resins (such as acrylic silicon-modified resin, fluorine-modified acrylic resin, urethans-modified acrylic resin and epoxy-modified acrylic resin); polyester-based resin, polyurethane-based resin, olefin-based resin, amide resin, imide resin, epoxy resin, silicone resin and vinyl acetate-based resin; natural polymers such as starch, gelatin and agar; semisynthetic polymers such as cellulose derivatives such as carboxymethyl cellulose, hydroxy ethyl cellulose, methyl cellulose, hydroxy ethyl methyl cellulose and hydroxy propyl methyl cellulose; and water-soluble polymers such as polyvinyl alcohol, polyacrylic acid-based polymer, polyacrylamide, polyethylene oxide and polyvinylpyrrolidone.

The solvent constituting the electrically conductive coating agent is not particularly limited, and examples of the solvent include: water, and organic solvents such as alcohols, glycols, cellosolves, ketones, esters, ethers, amides and hydrocarbons. Among these, it is preferable to use a solvent mainly composed of water or an alcohol. These may be used each alone or in combinations of two or more thereof.

The volume ratio (fibrous copper microparticles/binder) between the fibrous copper microparticles and the binder component in the electrically conductive coating agent of the present invention is preferably 1/100 to 5/1 and more preferably 1/20 to 1/1. When the volume ratio is less than 1/100, the electrical conductivity sometimes becomes low, for example, in the obtained electrically conductive layer. On the other hand, when the volume ratio exceeds 5/1, the electrically conductive layer obtained by applying the electrically conductive coating agent to a substrate sometimes undergoes the degradation of the adhesiveness to the substrate, and the electrically conductive layer is sometimes poor in the surface smoothness or in transparency.

The electrically conductive coating agent of the present invention contains, in addition to the fibrous copper microparticles and the binder, the solid contents of the additive(s) and the like added if necessary, and the concentration of the sum of these solid contents is preferably 1 to 99% by mass and more preferably 1 to 50% by mass, from the viewpoint of being excellent in the balance, for example, between the electrical conductivity and the handleability.

The viscosity of the electrically conductive coating agent of the present invention at 20° C. is preferably 0.5 to 100 mPa·s and more preferably 1 to 50 mPa·s from the viewpoint of being excellent, for example, in the handleability and the easiness in application to a substrate.

The electrically conductive coating agent of the present invention may contain a cross-linking agent such as an aldehyde-based, epoxy-based, melamine-based, or isocyanate based crosslinking agent, if necessary, within a range not impairing the advantageous effects of the present invention.

The electrically conductive layer of the present invention contains the fibrous copper microparticles of the present invention, and can be obtained, for example, by forming a layer with the electrically conductive coating agent of the present invention.

The electrically conductive film of the present invention includes on a substrate an electrically conductive layer, and can be obtained by forming the electrically conductive layer on the substrate.

The electrically conductive layer and the electrically conductive film of the present invention are excellent both in transparency and in electrical conductivity.

Examples of the method fox forming the electrically conductive layer include a wet coating formation method in which the surface of a substrate such as a plastic film is coated with the electrically conductive coating agent of the present invention, subsequently the electrically conductive coating agent on the substrate is dried, and then, if necessary, cured, and thus the layer can be formed. As the coating method, for example, the following methods can be used: a roll coating method, a bar coating method, a dip coating method, a spin coating method, a casting method, a die coating method, a blade coating method, a gravure coating method, a curtain coating method, a spray coating method and a doctor coat ing method.

The electrically conductive layer can also be produced by disposing the fibrous copper microparticles of the present invention on the surface of a substrate such as a plastic film, and by forming a coating layer for fixing the disposed fibrous copper microparticles.

The thickness of the electrically conductive layer is preferably, for example, about 0.1 to 10 μm, from the viewpoint of practicability or the like.

### EXAMPLES

Hereinafter, Examples of the present invention are described, but the present invention is not limited by these Examples at all.

The evaluation methods or the measurement methods of the residual rates of the dissolved oxygen concentration of the reducing compounds used in Examples and Comparative Examples, and the fibrous copper microparticles obtained in Examples and Comparative Examples are as follows.

(1) Residual Rates A and B of Dissolved Oxygen Concentration for Reducing Compounds

A few drops of a 10% sodium hydroxide aqueous solution were added to 500 g of pure water to prepare an alkaline aqueous solution (water temperature: 25° C.) the pH of which was adjusted to 10.4. By using a dissolved oxygen meter (DO-5509, manufactured by Lutron Electronic Enterprise Co., Ltd.), the dissolved oxygen concentration (the dissolved oxygen concentration (C_{g}) before the addition of the reducing compound) of the alkaline aqueous solution was measured.

In an open cylindrical vessel of 7.0 cm in diameter, 100 mL of the alkaline aqueous solution was placed, then, a reducing compound was added to the alkaline aqueous solution in an amount to give the concentration of the reducing compound of 0.50 mol/L, and the reducing compound was dissolved by stirring with a magnetic stirrer to such an extent that the aqueous solution did not swirl. While the aqueous solution was being stirred even after the completion of dissolution, the dissolved oxygen concentration in the aqueous solution was measured after 0.5 minute, 5 minutes, 10 minutes, 15 minutes, 30 minutes, 45 minutes and 60 minutes from the addition of the reducing compound. Thus, the dissolved oxygen concentration after 10 minutes was taken as the “dissolved oxygen concentration (C₁₀)” and the dissolved oxygen concentration after 60 minutes from the addition of the reducing compound was taken as the “dissolved oxygen concentration (C₆₀).”

Then, the residual rate A (the value A) of the dissolved oxygen, concentration was derived with the following formula [1], and the residual rate B (the value B) of the dissolved oxygen concentration was derived with the following formula [2]:

Residual rate A of dissolved oxygen concentration=(Dissolved oxygen concentration (C₁₀))/(dissolved oxygen concentration (C₀)) [1]

Residual rate B of dissolved oxygen concentration=(Dissolved oxygen concentration (C₆₀))/(dissolved oxygen concentration (C₁₀) [2]

In FIG. 3, for each of the various reducing compounds, the relation between the dissolved oxygen concentration (mg/L) in the alkaline aqueous solution and the time is shown.

(2) Minor Axis and Length of Fibrous Copper Microparticles and Minor Axis and Major Axis of Copper Particles

The aggregates of the fibrous copper microparticles were prepared, and were lightly disentangled by using an ultrasonic disperser in order that the fibrous copper microparticles might not be in close contact with each other. Then, the fibrous copper microparticles were observed by using a digital microscope (“VHX-1000, VHX-D500/510,” manufactured by Keyence Corp.). From the aggregates, 100 of the fibrous copper microparticles were selected, the minor axis and the length of each of the fibrous copper microparticles and the minor axis and the major axis of each of the copper particles were measured, and the average values of these measured values were taken as the minor axis and the length of the fibrous copper microparticles and the minor axis and major axis of the copper particles.

(3) Aspect Ratios of Fibrous Copper Microparticles and Copper Particles

The aspect ratio of the fibrous copper microparticles was derived by dividing the length of the fibrous copper microparticles determined in the foregoing (2) by the minor axis of the fibrous microparticles determined in the foregoing (2), and the aspect ratio of the copper particles was derived by dividing the major axis of the copper particles determined in the foregoing (2) by the minor axis of the copper particles determined in the foregoing (2).

(4) Number of Copper Particles Per One Fibrous Copper Microparticle

The number of the copper particles in 100 of the fibrous copper microparticles selected in the foregoing (2) was counted, and the number of the copper particles per one fibrous copper microparticle was derived by dividing the number of the copper particles by the number (100) of the fibrous copper microparticles.

### Example 1

In a 300-mL three-necked flask, 108.0 g of sodium hydroxide (2.7 mol, manufactured by Nacalai Tesque, Inc.) as an alkaline compound was dissolved in 180.0 g of pure water (dissolved oxygen concentration at 27° C.: 8.7 mg/L, hereinafter sometimes abbreviated as pure water A) at 27° C.

Next, to the resulting aqueous solution, an aqueous solution prepared by dissolving 0.145 g of copper nitrate trihydrate (0.60 mmol, manufactured by Nacalai Tesque, Inc.) as a copper salt for producing copper ion in 6.2 g of pure water A, and 0.81 g of ethylene-diamine (13 mmol, manufactured by Nacalai Tesque, Inc.) as a nitrogen-containing compound were added and stirred at 200 rpm to prepare a uniform blue aqueous solution.

In the obtained, aqueous solution, the molar ratio of the hydroxide ion of sodium hydroxide to copper ion is 4500, and the molar ratio of the nitrogen-containing compound to copper ion is 22.

To the aqueous solution, 1.2 g of an aqueous solution (4.4% by mass) of ascorbic acid (manufactured by Nacalai Tesque, Inc., the value A: 0.90, the value B: 0.67) as a reducing compound was added, and the three-necked flask was immersed in a hot water bath set at 80° C. while the stirring of the solution at 200 rpm was being continued. The color of the solution gradually changed from blue to light color, and the solution changed to almost colorless and transparent after 30 minutes. After a further elapsed time of 30 minutes, 4.8 g of the aqueous solution (4.4% by mass) of ascorbic acid was added (the total amount of ascorbic acid: 1.5 mmol, the molar ratio to copper ion: 2.5) and the stirring of the solution was continued for about 1 minute. Then, the stirring was terminated, the three-necked flask was taken out from the hot water bath, and the precipitation of the fibrous copper microparticles in the cooling process was visually verified. The inside of the three-necked flask was in a state of being filled with air during the reaction.

The precipitated fibrous copper microparticles were collected with a syringe, and were immersed in an ascorbic acid aqueous solution (10% by mass) lest the surface of the fibrous copper microparticles should be oxidized. Then, a fraction of the precipitates was sampled with a syringe, washed repeatedly three times with pure water, and then dried to remove pure water in a dryer set at 50° C., and thus, fibrous copper microparticles were obtained. The results of the various evaluations of the fibrous copper microparticles are shown in Table 1.

### Example 2

Fibrous copper microparticles were prepared in the same manner as in Example 1 except that in place of pure water A, pure water B (27° C.) having a dissolved oxygen concentration at 25° C. of 19.6 mg/L was used, and the various evaluations of the fibrous copper microparticles were performed.

### Example 3

Fibrous copper microparticles were prepared in the same manner as in Example 1 except that in place of ascorbic acid, erythorbic acid (manufactured by Nacalai Tesque, Inc., the value A: 0.96, the value B: 0.73) was used as the reducing compound, and the various evaluations of the fibrous copper microparticles were performed.

### Example 4

Fibrous copper microparticles were prepared in the same manner as in Example 1 except that in place of ascorbic acid, glucose (manufactured by Nacalai Tesque, Inc., the value A: 0.97, the value B: 0.92) was used as the reducing compound, and the various evaluations of the fibrous copper microparticles were performed.

### Comparative Example 1

In the same manner as in Example 1, a uniform blue aqueous solution containing sodium hydroxide, copper nitrate trihydrate and ethylenediamine was prepared.

To the aqueous solution, 0.015 g of hydrazine monohydrate (manufactured by Nacalai Tesque, Inc., the value A: 0.03) was added, and the three-necked flask was immersed in a hot water bath set at 80° C. while the stirring of the solution at 200 rpm was being continued. The color of the solution, changed from blue to light color, and the solution changed to almost colorless and transparent after 5 minutes. After a further elapsed time of 30 minutes, 0.06 g of hydrazine monohydrate was added (the total amount of hydrazine monohydrate: 1.5 mmol, the molar ratio to copper ion: 2.5) and the stirring of the solution was continued for about 1 minute. Then, the stirring was terminated, the three-necked flask was taken out from the hot water bath, and the precipitation of the fibrous copper microparticles in the cooling process was visually verified. It is to be noted that the inside of the three-necked, flask was in a state of being filled with air during the reaction. The obtained precipitates were taken out, in the same manner as in Example 1. For the precipitates, various evaluations were performed.

### Comparative Example 2

In the same manner as in Example 1, a uniform blue aqueous solution containing sodium hydroxide, copper nitrate trihydrate and ethylenediamine was prepared.

To the solution, 0.075 g of hydrazine monohydrate (1.5 mmol, the molar ratio to copper ion: 2.5) was added, and the three-necked flask was immersed in a hot water bath set at 80° C. while the stirring of the solution at 200 rpm was being continued. Immediately, the color of the solution changed from blue and the solution turned colorless and transparent, and precipitates occurred. Subsequently, after 30 minutes, the three-necked flask was taken out from the hot water bath. It is to be noted that the inside of the three-necked flask was in a state of being filled with air during the reaction. The obtained precipitates were taken out in the same manner as in Example 1. For the precipitates, various evaluations were performed.

### Comparative Example 3

In a 300-mL three-necked flask, 108.0 g of sodium hydroxide (2.7 mol) was dissolved in 180.0 g of pure water A at 27° C. Next, an aqueous solution prepared by dissolving 0.217 g of copper nitrate trihydrate (0.90 mmol) in 9.2 g of pure water A, and 1.2 g of ethylenediamine (20 mmol) were added and stirred at 200 rpm to prepare a uniform blue aqueous solution. In the obtained aqueous solution, the molar ratio of the hydroxide ion of sodium hydroxide to copper ion is 3000, and the molar ratio of the nitrogen-containing compound to copper ion is 22.

To the aqueous solution, 0.023 g of hydrazine monohydrate as a reducing compound was added, and the three-necked flask was immersed in a hot water bath set at 80° C. while the stirring of the solution at 200 rpm was being continued. The color of the solution changed from blue to light color, and the solution changed to almost colorless and transparent after 5 minutes. After a further elapsed time of 30 minutes, 0.090 g of hydrazine monohydrate was added (the total amount of hydrazine monohydrate: 2.3 mmol, the molar ratio to copper ion: 2.5) and the stirring of the solution was continued for about 1 minute. Then, the stirring was terminated, the three-necked flask was taken out from the hot water bath, and the precipitation of the fibrous copper microparticles in the cooling process was visually verified. It is to be noted that the inside of the three-necked flask was in a state of being filled with air during the reaction. The obtained precipitates were taken out in the same manner as in Example 1. For the precipitates, various evaluations were performed.

### Comparative Example 4

In the same manner as in Comparative Example 3, a uniform blue aqueous solution containing sodium hydroxide, copper nitrate trihydrate and ethylenediamine was prepared.

To the solution, 0.19 g of hydrazine monohydrate (3.8 mmol, the molar ratio to copper ion: 4.2) was added, and the three-necked flask was immersed in a hot water bath set at 80° C. while the stirring of the solution at 200 rpm was being continued. Immediately, the color of the solution changed from blue and the solution turned colorless and transparent, and precipitates occurred. Subsequently, after 30 minutes, the three-necked flask was taken out from the hot water bath. It is to be noted that the inside of the three-necked flask was in a state of being filled with air during the reaction. The obtained precipitates were taken out in the same manner as in Example 1. For the precipitates, various evaluations were performed.

### Comparative Example 5

In the same manner as in Example 1, a uniform blue aqueous solution containing sodium hydroxide, copper nitrate trihydrate and ethylenediamine was prepared.

To the solution, 0.20 g of an aqueous solution (4.4% by mass) of sodium borohydride (manufactured by Nacalai Tesque, Inc., the value A: 0.01) was added, and the three-necked flask was immersed in a hot water bath set at 80° C. while the stirring of the solution at 200 rpm was being continued. Because even after an elapsed time of 30 minutes, the color of the solution stayed blue without any change, 1.04 g of an aqueous solution (4.4% by mass) of sodium borohydride was further added (the total amount of sodium borohydride: 1.5 mmol, the molar ratio to copper ion: 2.5), and the stirring of the solution was continued further for 30 minutes, but the color of the solution stayed blue without any change and no precipitates were obtained. It is to be noted, that the inside of the three-necked flask was in a state of being filled with air during the reaction.

Table 1 shows the production conditions of the fibrous copper microparticles and the evaluation results of the obtained fibrous copper microparticles in each of Examples 1 to 4 and Comparative Examples 1 to 5.

TABLE 1

| | | Production conditions of fibrous copper microparticles | | | | | | | |
|---|---|---|---|---|---|---|---|---|---|
| | | | Alkaline compound | | | | | | |
| | | | Number | Molar | | | | | |
| | | Copper | of moles | ratio of | Nitrogen-containing | | | | |
| | | ion | of | hydroxide | compound | | | | |
| | | Number | hydroxide | ion to | Number of | Molar ratio | | | |
| | | of moles | ion | copper | moles | to copper | Reducing compound | | |
| | | (mmol) | (mol) | ion | (mmol) | ion | Type | Value A | Value B |
| Examples | 1 | 0.60 | 2.7 | 4500 | 13 | 22 | Ascorbic acid | 0.90 | 0.67 |
| | 2 | 0.60 | 2.7 | 4500 | 13 | 22 | Ascorbic acid | 0.90 | 0.67 |
| | 3 | 0.60 | 2.7 | 4500 | 13 | 22 | Erythorbic acid | 0.96 | 0.73 |
| | 4 | 0.60 | 2.7 | 4500 | 13 | 22 | Glucose | 0.97 | 0.92 |
| Comparative | 1 | 0.60 | 2.7 | 4500 | 13 | 22 | Hydrazine | 0.03 | — |
| Examples | 2 | 0.60 | 2.7 | 4500 | 13 | 22 | Hydrazine | 0.03 | — |
| | 3 | 0.90 | 2.7 | 3000 | 20 | 22 | Hydrazine | 0.03 | — |
| | 4 | 0.90 | 2.7 | 3000 | 20 | 22 | Hydrazine | 0.03 | — |
| | 5 | 0.60 | 2.7 | 4500 | 13 | 22 | Sodium borohydride | 0.01 | — |

| | | | | | | Evaluation of fibrous copper | | | |
|---|---|---|---|---|---|---|---|---|---|
| | | | | | | microparticles | | | |
| | | | | | | | | | Number of |
| | | Production conditions of | | | | | | | copper |
| | | fibrous copper microparticles | | | | | | | particles |
| | | Reducing compound | | | | | | | Number of |
| | | Number | | | Water | Shape of fibrous copper | | | copper |
| | | of times | Total | Molar | Dissolved | microparticles | | | particles per |
| | | of | number | ratio to | oxygen | Minor | | | one fibrous |
| | | divided | of moles | copper | concentration | axis | Length | Aspect | copper |
| | | addition | (mmol) | ion | (mg/l) | (μm) | (μm) | ratio | microparticle |
| Examples | 1 | 2 | 1.5 | 2.5 | 8.7 | 0.07 | 122 | 1740 | 0.06 |
| | 2 | 2 | 1.5 | 2.6 | 19.6 | 0.11 | 23 | 209 | 0.08 |
| | 3 | 2 | 1.5 | 2.5 | 8.7 | 0.09 | 65 | 722 | 0.06 |
| | 4 | 2 | 1.5 | 2.5 | 8.7 | 0.08 | 33 | 413 | 0.09 |
| Comparative | 1 | 2 | 1.5 | 2.5 | 8.7 | 0.14 | 4.5 | 32 | 0.8 |
| Examples | 2 | 1 | 1.5 | 2.5 | 8.7 | 0.50 | 11 | 22 | 0.8 |
| | 3 | 2 | 2.3 | 2.6 | 8.7 | 0.19 | 18 | 95 | 0.7 |
| | 4 | 1 | 3.8 | 4.2 | 8.7 | 0.13 | 14 | 108 | 0.5 |

| | | | | | |
|---|---|---|---|---|---|
| 5 | 2 | 1.5 | 2.5 | 8.7 | No precipitates were obtained. |

In the table, the value A is the residual rate A of the dissolved oxygen concentration, in an alkaline aqueous solution at pH 10.4, derived with (dissolved oxygen concentration (C₁₀) after 10 minutes from the addition of the reducing compound)/(the dissolved oxygen concentration(C₁₀) before the addition of reducing compound.
In the table, the Value B is the residual rate B of the dissolved oxygen concentration, in the same aqueous solution as described above, derived with (the dissolved oxygen concentration (C₆₀) after 60 minutes from the addition of the reducing compound)/(the dissolved oxygen concentration (C₁₀) after 10 minutes from the addition of the reducing compound).
In the table, the number of the copper particles is the number of the copper particles having a minor axis of 0.3 μm or more and an aspect ratio of 1.6 or less, contained per one fibrous copper microparticle.

The fibrous copper microparticles obtained in each of Examples 1 to 4 had a minor axis of 1 μm or less and an aspect ratio of 10 or more, and the content of the copper particles having a minor axis of 0.3 μm or more and an aspect ratio of 1.5 or less was 0.1 or less copper particle per one fibrous copper microparticle.

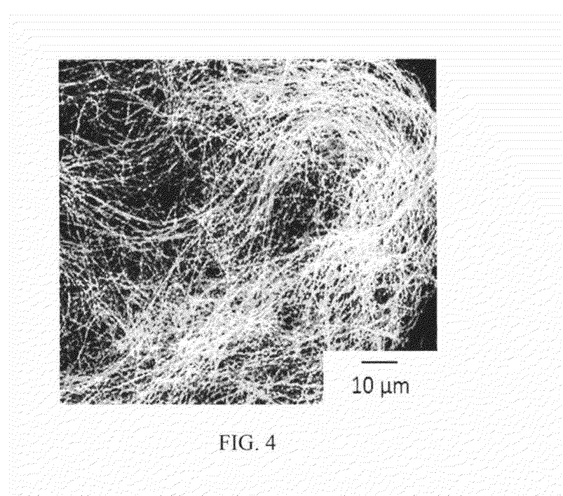

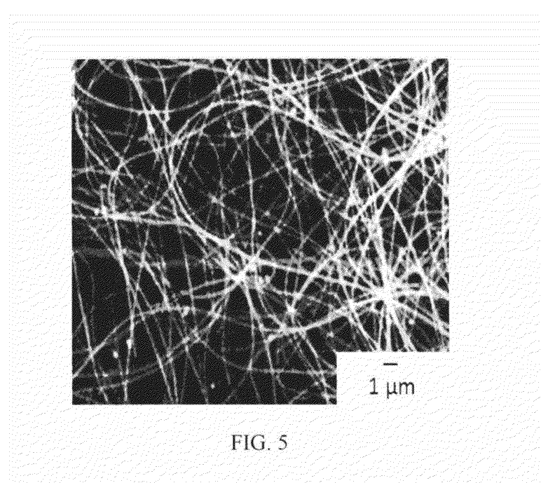

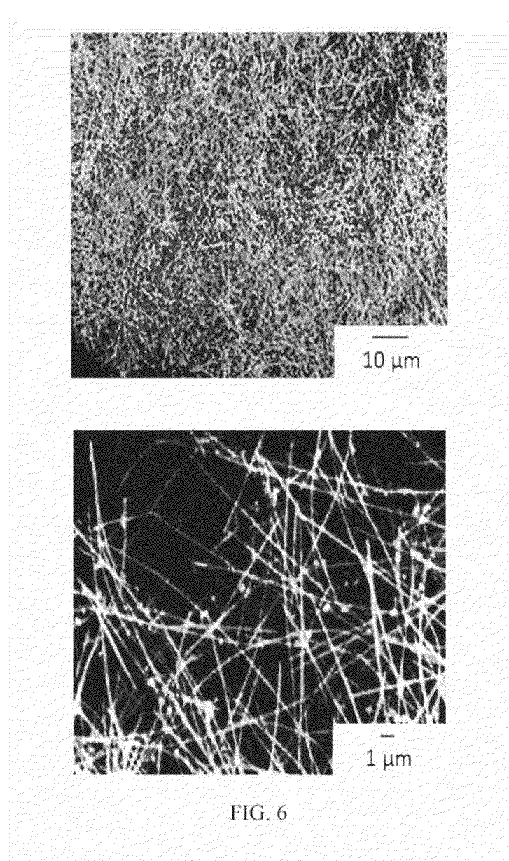

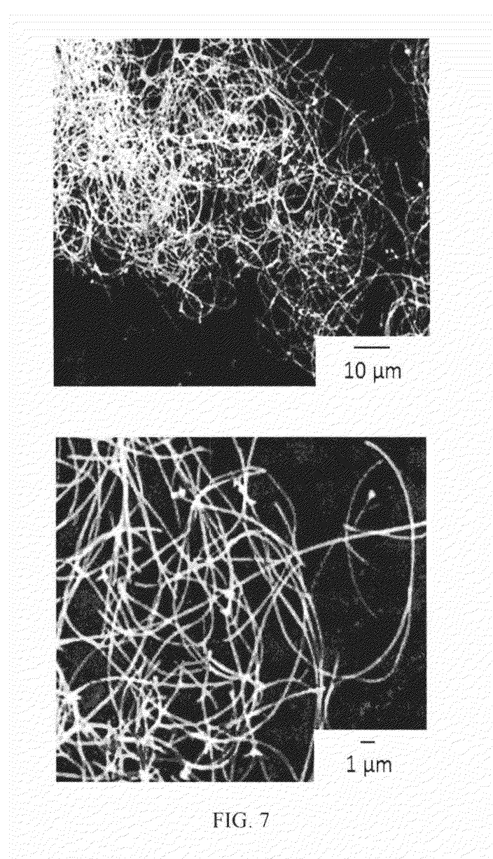

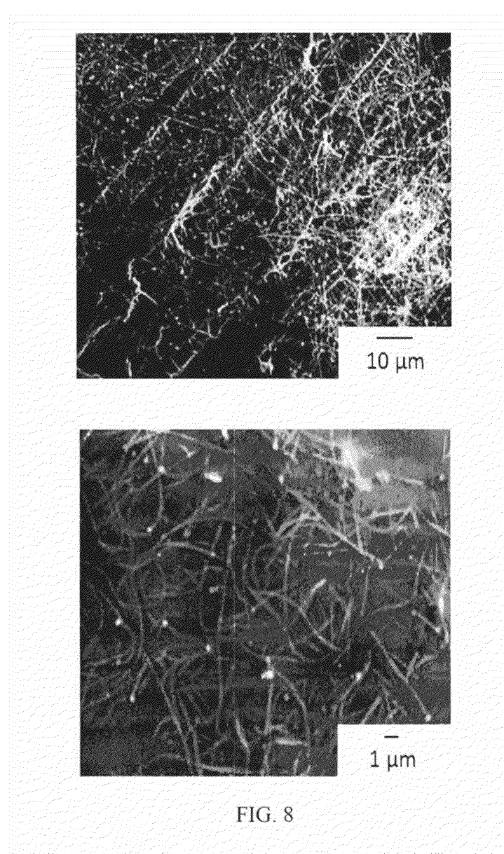

FIGS. 4 to 8 show the observation views obtained by observing the fibrous copper microparticles obtained in Examples 1 to 4 with a digital microscope. As can be seen from FIGS. 4 to 8, in the fibrous copper microparticles obtained in each of Examples 1 to 4, the formation of the copper particles having a minor axis of 0.3 μm or more and an aspect ratio of 1.5 or less was suppressed.

The fibrous copper microparticles obtained in each of Comparative Examples 1 to 4 were obtained by using the reducing compound having the value A of less than 0.5, and hence, contained the copper particles having a minor axis of 0.3 μm or more and an aspect ratio of 1.5 or less in a content exceeding 0.1 copper particle per one fibrous copper microparticle, although in the fibrous copper microparticles obtained in each of Comparative Examples 1 to 4, the minor axis was 1 μm or less and the aspect ratio was 10 or more.

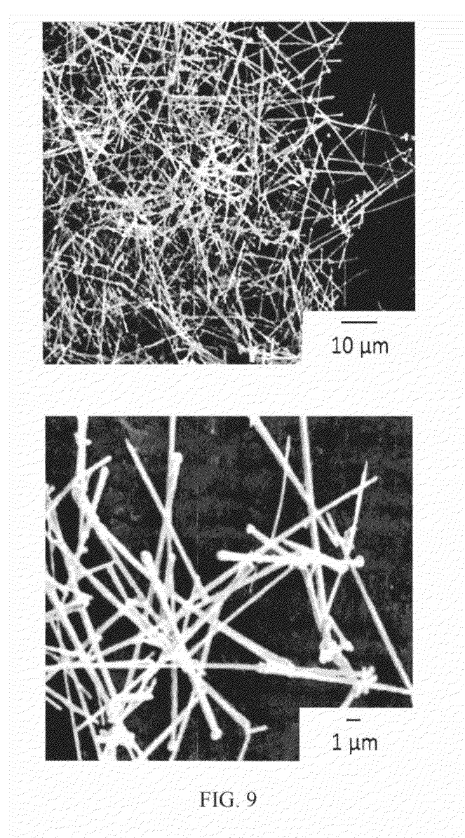

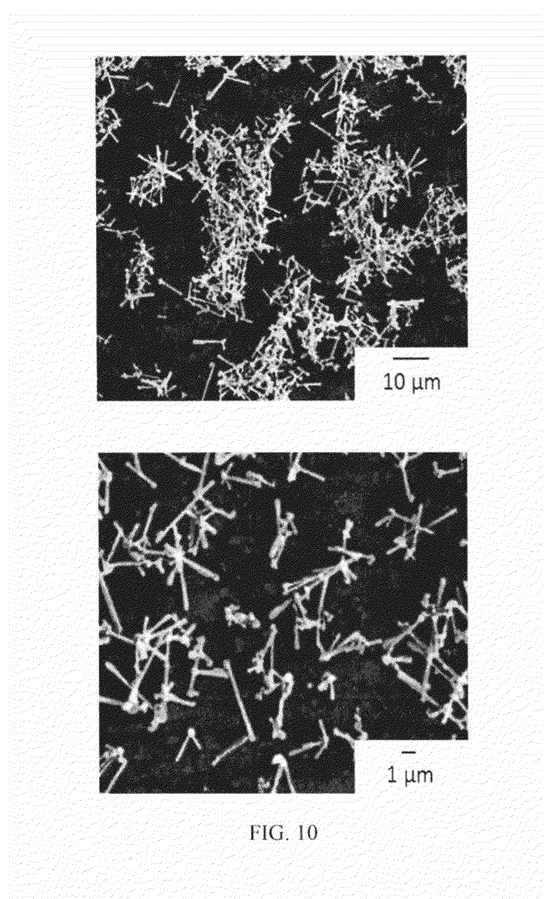

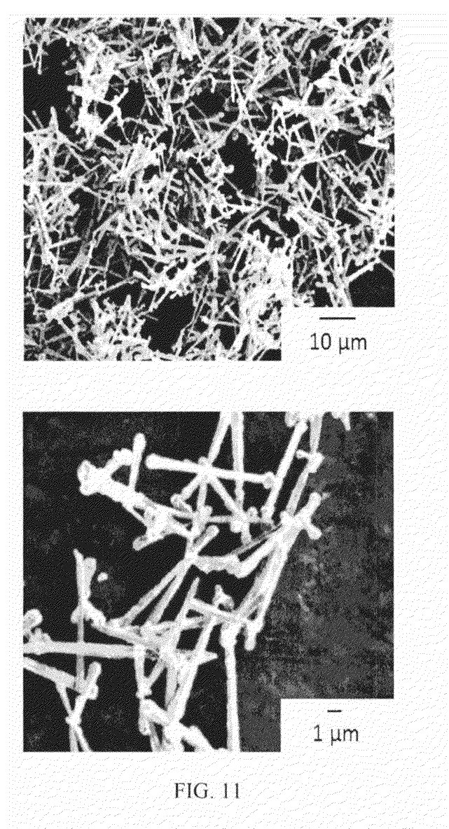

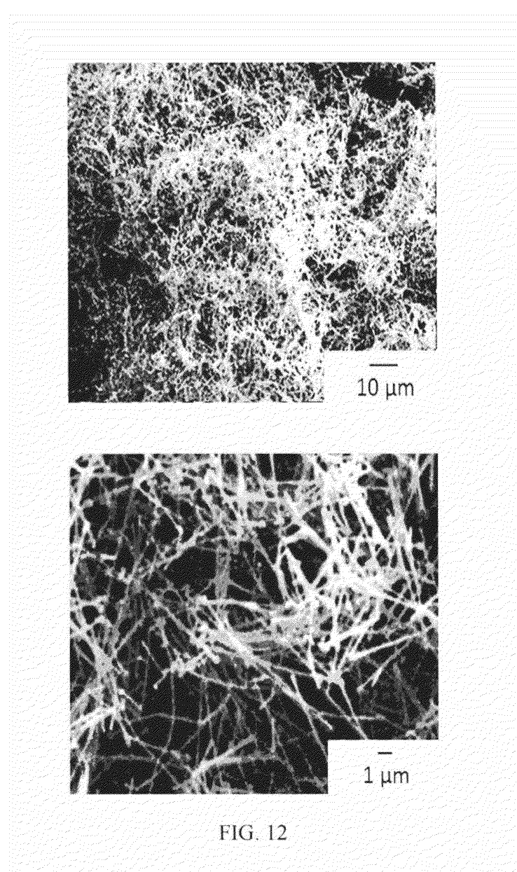

FIGS. 9 to 12 show the observation views obtained by observing the fibrous copper microparticles obtained in Comparative Examples 1 to 4 with a digital microscope. As can be seen from FIGS. 9 to 12, in the fibrous copper microparticles obtained in each of Comparative Examples 1 to 4, a large number of the copper particles having a minor axis of 0.3 μm or more and an aspect ratio of 1.5 or less were formed.

In Comparative Example 5, another reducing compound having the value A less than 0.5 was used, and even the production of the fibrous copper microparticles was impossible.

1. Fibrous copper microparticles having a minor axis of 1 μm or less and an aspect ratio of 10 or more, wherein a content of copper particles having a minor axis of 0.3 μm or more and an aspect ratio of 1.5 or less is 0.1 or less copper particle per one fibrous copper microparticle.

2. The fibrous copper microparticles according to claim 1, wherein a length of the fibrous copper microparticles is 1 μm or more.

3. A method for manufacturing the fibrous copper microparticles according to claim 1, comprising precipitating the fibrous copper microparticles from an aqueous solution containing copper ion, an alkaline compound, a nitrogen-containing compound to form a complex with copper ion, and a reducing compound, wherein a residual rate A of a dissolved oxygen concentration in the alkaline aqueous solution represented by the following formula [1] is 0.5 or more:
Residual rate A of dissolved oxygen concentration=(Dissolved oxygen concentration (C₁₀) after 10 minutes from addition of reducing compound)/(dissolved oxygen concentration (C₀) before addition of reducing compound) [1]

4. The method for manufacturing fibrous copper microparticles according to claim 3, wherein the reducing compound is one or more compounds selected from ascorbic acid, erythorbic acid and glucose.

5. The method for manufacturing fibrous copper microparticles according to claim 3, wherein a residual rate B of the dissolved oxygen concentration in the alkaline aqueous solution represented by the following formula [2] is 0.9 or less:
Residual rate B of dissolved oxygen concentration=(Dissolved oxygen concentration (C₆₀) after 60 minutes from addition of reducing compound)/(dissolved oxygen concentration (C₁₀) after 10 minutes from addition of reducing compound) [2]

6. The method for manufacturing fibrous copper microparticles according to claim 5, wherein the reducing compound is ascorbic acid and/or erythorbic acid.

7. An electrically conductive coating agent comprising the fibrous copper microparticles according to claim 1.

8. An electrically conductive layer comprising the fibrous copper microparticles according to claim 1.

9. An electrically conductive film comprising a substrate, and the electrically conductive layer according to claim 8, formed on the substrate.

10. A method for manufacturing the fibrous copper microparticles according to claim 2, comprising precipitating the fibrous copper microparticles from an aqueous solution containing copper ion, an alkaline compound, a nitrogen-containing compound to form a complex with copper ion, and a reducing compound, wherein a residual-rate A of a dissolved oxygen concentration in the alkaline aqueous solution represented by the following formula [1] is 0.5 or more:
Residual rate A of dissolved oxygen concentration=(Dissolved oxygen concentration (C₁₀) after 10 minutes from addition of reducing compound)/(dissolved oxygen concentration (C₀) before addition of reducing compound) [1]

11. The method for manufacturing fibrous copper microparticles according to claim 10, wherein the reducing compound is one or more compounds selected from ascorbic acid, erythorbic acid and glucose.

12. The method for manufacturing fibrous copper microparticles according to claim 10, wherein a residual rate B of the dissolved oxygen concentration in the alkaline aqueous solution represented by the following formula [2] is 0.9 or less:
Residual rate B of dissolved oxygen concentration=(Dissolved oxygen concentration (C₆₀) after 60 minutes from addition of reducing compound)/(dissolved oxygen concentration (C₁₀) after 10 minutes from addition of reducing compound) [2]

13. The method for manufacturing fibrous copper microparticles according to claim 12, wherein the reducing compound is ascorbic acid and/or erythorbic acid.

14. An electrically conductive coating agent comprising the fibrous copper microparticles according to claim 2.

15. An electrically conductive layer comprising the fibrous copper microparticles according to claim 2.

16. An electrically conductive film comprising a substrate, and the electrically conductive layer according to claim 15, formed on the substrate.
